(19) United States
(12) Patent Application Publication
(10) Pub. No.: US 2026/0154016 A1
(43) Pub. Date: Jun. 4, 2026

(54) INFORMATION PROCESSING SYSTEM AND METHOD FOR CONTROLLING INFORMATION PROCESSING SYSTEM

(71) Applicant: CANON KABUSHIKI KAISHA, Tokyo (JP)

(72) Inventor: HIROSHI OYA, Tokyo (JP)

(21) Appl. No.: 19/400,730

(22) Filed: Nov. 25, 2025

(30) Foreign Application Priority Data
Dec. 4, 2024 (JP) 2024-211077

(51) Int. Cl. G06F 3/12

(52) U.S. Cl. CPC G06F 3/1226; G06F 3/1204; G06F 3/1236; G06F 3/1288

(57) ABSTRACT

Accuracy of detecting predetermined consumables and non-predetermined consumables created by copying memories of the predetermined consumables has not been excellent. A method for controlling an information processing system including an image forming apparatus and an information processing apparatus communicable with the image forming apparatus over a network includes receiving information regarding a consumable mounted in the image forming apparatus, determining whether the consumable is a predetermined consumable on a basis of the information regarding the consumable and information regarding another consumable stored before the information regarding the consumable is received from the image forming apparatus, transmitting a determination result obtained in the determining to the image forming apparatus, writing information regarding the determination result and a valid period to a memory of the mounted consumable, and transmitting an inquiry including the information written to the memory of the consumable to the information processing apparatus.

### BACKGROUND

### Field of the Technology

The present disclosure relates to an information processing system and a method for controlling an information processing system.

### Description of the Related Art

Image forming apparatuses having a function of obtaining information regarding a remaining amount of a consumable thereof, such as a toner cartridge, from the consumable and displaying the information are known.

There are, however, non-predetermined cartridges that can be used in image forming apparatuses but whose printing performance is not guaranteed in addition to predetermined cartridges whose printing performance in the image forming apparatuses is guaranteed by manufacturers or the like of the image forming apparatuses. It is technically possible to copy information stored in a predetermined cartridge that has not been used or that is in use. By storing the copied information in a non-predetermined cartridge, the non-predetermined cartridge can be disguised as the predetermined cartridge.

The following concerns arise when such a non-predetermined cartridge is used. For example, if components of toner contained in the non-predetermined cartridge are not optimized for an image forming apparatus, printing performance desired by a user might not be achieved. In addition, because an initial amount of toner contained in the non-predetermined cartridge and the amount of toner consumed by the non-predetermined cartridge during printing might be different from those of a predetermined cartridge, it might not be possible to correctly notify a user of the remaining amount of toner and a replacement timing.

If it is possible to correctly determine whether a predetermined cartridge is mounted in an image forming apparatus, this information can be used to determine whether a cause of the above-described issue relating to the notification of the remaining amount and the replacement timing is attributable to a cartridge mounted in the image forming apparatus or to other components.

When a non-predetermined cartridge storing copied information is mounted, however, it is difficult to correctly determine whether the cartridge is a predetermined cartridge. When a non-predetermined cartridge storing copied information is mounted in an image forming apparatus, therefore, it is difficult to notify a user of the mounting of the non-predetermined cartridge. In order to address this problem, a method in Japanese Patent Laid-Open No. 2019-121186 has been proposed as a method for correctly determining whether a mounted cartridge is a non-predetermined cartridge storing copied information. Japanese Patent Laid-Open No. 2019-121186 discloses a method in which information regarding consumables mounted in image forming apparatuses is collected in a management server, and if the collected information includes a plurality of cartridges having the same cartridge identifier, the cartridges are determined as non-predetermined cartridges.

When the method in Japanese Patent Laid-Open No. 2019-121186 is used, however, a predetermined cartridge that has been used in a plurality of image forming apparatuses might be erroneously recognized as a non-predetermined cartridge.

The erroneous recognition can occur, for example, when a user to whom no other cartridges are available desires to use one cartridge in a plurality of image forming apparatuses and when quality of a plurality of image forming apparatuses is checked using one cartridge in a factory for manufacturing image forming apparatuses. Especially in the former case, even though the user has purchased the predetermined cartridge, a warning indicating a non-predetermined cartridge is displayed, which might confuse the user and cause the user to lose trust.

### SUMMARY

According to an aspect of the present disclosure, there is provided a mechanism for improving accuracy of detecting a non-predetermined cartridge storing copied information and, if a non-predetermined cartridge is mounted in an image forming apparatus, correctly notifying a user of the mounting of the non-predetermined cartridge.

An information processing system includes an image forming apparatus and an information processing apparatus communicable with the image forming apparatus over a network. The information processing apparatus includes at least one memory that stores a set of instructions, and at least one processor that executes the instructions causing the information processing apparatus to perform operations including a reception unit configured to receive information regarding a consumable mounted in the image forming apparatus, a determination unit configured to determine whether the consumable is a predetermined consumable on a basis of the information regarding the consumable and information regarding another consumable stored before the information regarding the consumable is received from the image forming apparatus, and a first transmission unit configured to transmit a determination result obtained by the determination unit to the image forming apparatus. The information regarding the other consumable includes a last determination result obtained by the determination unit and a valid period. The image forming apparatus includes at least one memory that stores a set of instructions, and at least one processor that executes the instructions causing the image forming apparatus to perform operations including a writing unit configured to write, if the determination result received from the information processing apparatus indicates the predetermined consumable, information regarding the determination result and a valid period to a memory of the mounted consumable, and a second transmission unit configured to transmit an inquiry including the information written to the memory of the consumable to the information processing apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating overall configuration of a processing system.

FIG. 2 is a diagram illustrating hardware configuration of an image forming apparatus.

FIG. 3 is a diagram illustrating hardware configuration of a device management server.

FIG. 4 is a diagram illustrating a memory map of a cartridge memory.

FIG. 5 is a diagram illustrating a mounted cartridge list created by a device management server.

FIG. 6 illustrates an authentication sequence at a time when a new cartridge is mounted in an embodiment.

FIG. 7 is a flowchart illustrating a process for authenticating a cartridge by the device management server in the embodiment.

FIG. 8 is a flowchart illustrating a process at a time of reception of an authentication result by the image forming apparatus in the embodiment.

FIG. 9 illustrates a screen for notifying a user that a non-predetermined cartridge is mounted.

### DESCRIPTION OF THE EMBODIMENTS

An embodiment of the present disclosure will be described in detail hereinafter with reference to the drawings. The following embodiment is not intended to limit what is disclosed in the claims, and not all combinations of features described in the embodiment are necessary for the solution in the present disclosure.

Although an image forming apparatus will be described as a multifunction peripheral of an electrophotographic type and a consumable will be described as a toner cartridge in the present embodiment, the image forming apparatus and the consumable are not limited to these. For example, the image forming apparatus may be an inkjet printer, and the consumable may be an ink cartridge.

A manufacturer of an image forming apparatus might use a term "predetermined cartridge" or "predetermined article" for a cartridge assumed to be used in the image forming apparatus.

The manufacturer of the image forming apparatus might use a term "non-predetermined cartridge" or "non-predetermined article" for a cartridge not assumed to be used in the image forming apparatus. In the following embodiment, an example will be described in which a non-predetermined cartridge disguised as a predetermined cartridge by storing a copy of information stored in the predetermined cartridge is determined as a non-predetermined cartridge. A method for preventing a predetermined cartridge from being erroneously determined as a non-predetermined cartridge when the predetermined cartridge is used in a plurality of image forming apparatuses will also be described.

### First Embodiment

A first embodiment of the present disclosure will be described.

### Hardware Configuration of Processing System

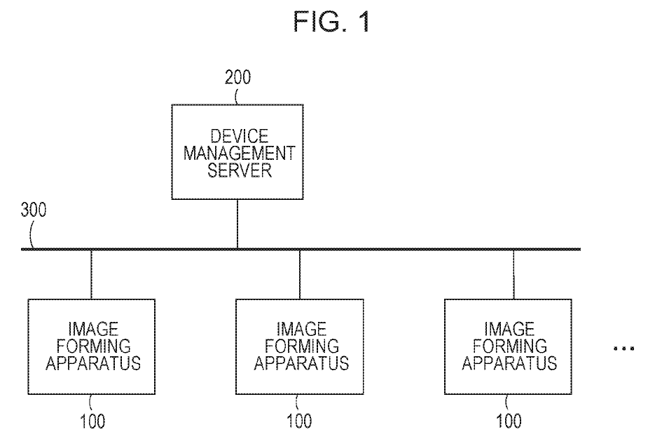

FIG. 1 is a configuration diagram illustrating overall hardware configuration of a processing system according to the present embodiment. In the processing system, a plurality of image forming apparatuses 100 as processing apparatuses and a device management server 200 that is an information processing apparatus are communicably connected to each other via a communication network 300 such as the Internet.

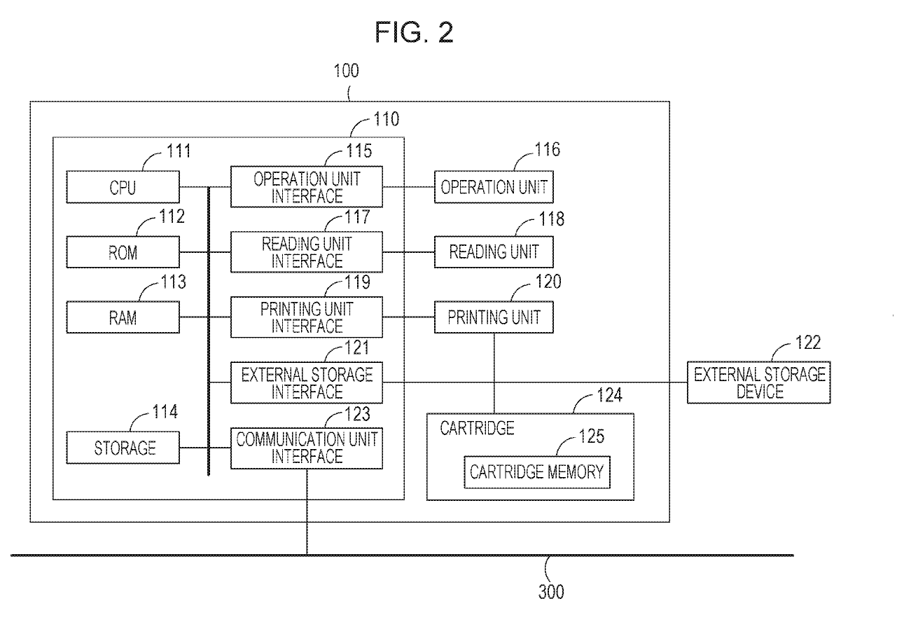

Each image forming apparatus 100 holds use condition information, various types of setting information, and the like regarding the image forming apparatus 100 in a storage 114 (see FIG. 2) thereof. The use condition information includes information regarding mounting records of cartridges. When the image forming apparatus 100 receives a request to obtain information held therein from the device management server 200 via the communication network 300, the image forming apparatus 100 transmits the information to the device management server 200 in response to the request.

The device management server 200 is an information processing apparatus that holds and manages the use condition information and the various types of setting information received from the plurality of image forming apparatuses 100.

The communication network 300 may have a network configuration wirelessly connected to an access point (not illustrated) insofar as communication, such as transmission of image data, can be performed.

A communication protocol such as Hypertext Transfer Protocol (HTTP) is used for the communication between the image forming apparatuses 100 and the device management server 200. A known control method is used for the communication.

### Image Forming Apparatus

FIG. 2 is a diagram illustrating an example of hardware configuration of the image forming apparatus 100.

A control unit 110 including a central processing unit (CPU) 111 controls overall operation of the image forming apparatus 100. The CPU 111 reads control programs stored in a read-only memory (ROM) 112 or the storage 114 and performs various types of control including reading control and printing control.

The ROM 112 stores control programs executable by the CPU 111. The ROM 112 also stores a boot program, font data, and the like.

A random-access memory (RAM) 113 is a main storage memory of the CPU 111 and used as a work area, that is, a temporary storage region for loading the various control programs stored in the ROM 112 and the storage 114.

The storage 114 stores image data, print data, an address book, various programs, and various types of setting information. Although a flash memory is assumed as the storage 114 in the present embodiment, an auxiliary storage device such as a solid-state drive (SSD), a hard disk drive (HDD), or an embedded MultiMediaCard (eMMC) may be used instead.

Although a single CPU 111 is assumed to perform processing in each of flowcharts referred to later using a single memory (RAM 113) in each image forming apparatus 100, another mode may be employed instead.

For example, a plurality of CPUs, RAMs, ROMs, and storages may operate together to perform the processing in each flowchart referred to later. A part of the processing may be performed using a hardware circuit such as an application-specific integrated circuit (ASIC) or a field-programmable gate array (FPGA).

An operation unit interface 115 connects an operation unit 116 and the control unit 110 to each other.

The operation unit 116 displays information to a user and detects inputs from the user.

A reading unit interface 117 connects a reading unit 118 and the control unit 110 to each other.

The reading unit 118 reads an image on a document and converts the image into image data such as binary data. The CPU 111 then performs encryption and image processing on the image data generated by the reading unit 118 in accordance with settings at a time of the reading. The image data generated through the various types of processing is transmitted to the device management server 200, saved to an external storage device 122, or printed on a recording sheet in a printing unit 120. State information regarding the reading unit 118 including a reading condition and error information is stored in the RAM 113 and transmitted to the CPU 111.

A printing unit interface 119 connects the printing unit 120 and the control unit 110 to each other. The CPU 111 transmits image data to be printed (print target image data) to the printing unit 120 via the printing unit interface 119.

The printing unit 120 prints an image on a recording sheet fed from a paper feed cassette (not illustrated) using toner contained in a cartridge 124. The printing unit 120 stores state information regarding the printing unit 120 including a printing condition, error information, and information regarding the cartridge 124 in the RAM 113 and transmits the state information to the CPU 111.

An external storage interface 121 connects the external storage device 122 and the control unit 110 to each other. The CPU 111 saves image data to the external storage device 122 via the external storage interface 121.

Although the external storage interface 121 is assumed to be a universal serial bus (USB) interface and the external storage device 122 is assumed to be a USB memory in the present embodiment, an external storage device such as a secure digital (SD) card may be used, instead.

The control unit 110 is connected to the communication network 300 by a communication unit interface 123.

The communication unit interface 123 can transmit various types of information inside the image forming apparatus 100 to the device management server 200. Here, the various types of information inside the image forming apparatus 100 refer to various types of setting information regarding the operation of the image forming apparatus 100, use condition information regarding the image forming apparatus 100 including the number of sheets printed and error information, and the like. The communication unit interface 123 also receives, from the device management server 200, a request to refer to the various types of information inside the image forming apparatus 100 or a request to change the setting information and reads the various types of information in the storage 114 or change the setting information.

The transmission of the various types of information to the device management server 200 and reception of contract information and the request to change the setting information from the device management server 200 are performed by a webserver application that processes HTTP.

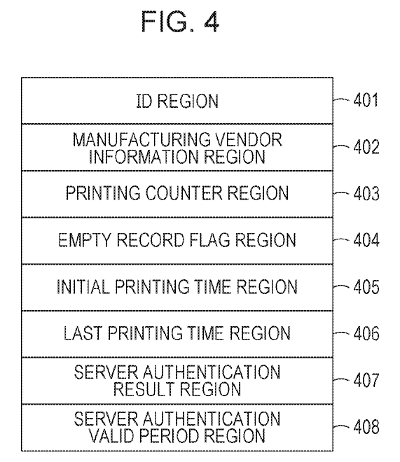

The cartridge 124 is, as a containing unit that contains toner, a so-called process cartridge that can be mounted in the image forming apparatus 100 and contains toner or the like to be used when the printing unit 120 forms an image. The cartridge 124 includes a cartridge memory 125 that is a nonvolatile storage medium, and the cartridge memory 125 stores information regarding the cartridge 124. Details of the information stored in the cartridge memory 125 will be described later with reference to FIG. 4. Although the information regarding the cartridge 124 is obtained by the printing unit 120 and transmitted to the CPU 111 and the storage 114 via the printing unit interface 119 in the present embodiment, the cartridge 124 may be directly connected to the CPU 111 or the like, instead.

### Device Management Server

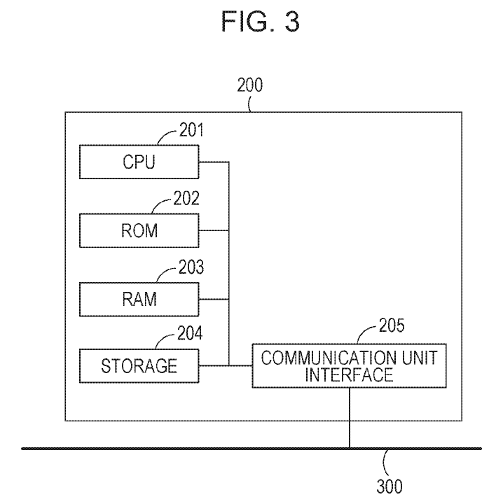

FIG. 3 illustrates an example of hardware configuration of the device management server 200, which is the information processing apparatus.

A CPU 201 loads a program stored in a ROM 202 or a storage 204 into a RAM 203 and executes the program to perform processing such as processing of data and instructions, determinations, and control.

The RAM 203 is used as a temporary storage region for the CPU 201 to perform various types of processing.

The storage 204 stores an operating system (OS), application software, programs, and the like. A mounted cartridge list 500, which will be described later, and the various types of setting information (not illustrated) regarding the image forming apparatus 100 are also stored in the storage 204.

The communication unit interface 205 communicates data with devices connected to the same communication network 300 or the Internet using a wireless local area network (LAN) or a wired LAN compatible with a standard such as Institute of Electrical and Electronics Engineers (IEEE) 802.11a and a protocol such as Transmission Control Protocol/Internet Protocol (TCP/IP).

The present embodiment is not limited to the configuration illustrated in FIG. 3, and may have a configuration for achieving the functions of the device management server 200 using a cloud server, instead. The device management server 200 need not be achieved by a single server, and the functions provided by the device management server 200 may be achieved by a server system including a plurality of servers, instead. This is more desirable because information can be collected from image forming apparatuses 100 all over the world.

### Memory Map of Cartridge Memory

FIG. 4 illustrates an example of a memory map of the cartridge memory 125 of the cartridge 124.

An identifier (ID) region 401 is a region in which a unique ID for identifying each cartridge 124 is written. The unique ID is uniquely allocated to each cartridge 124. In the present embodiment, for example, the unique IDs are serial numbers.

A manufacturing vendor information region 402 is a region in which information indicating a vendor of each cartridge 124 is written.

A printing counter region 403 is a region in which a cumulative counter of the number of sheets printed with each cartridge 124 mounted in the image forming apparatus 100 is written.

An empty record flag region 404 is a region in which information indicating whether each cartridge 124 has been determined by a controller to be empty (ON) or not (OFF). Once rewritten to ON, an empty record flag is no longer rewritten to OFF.

An initial printing time region 405 is a region in which a time when each cartridge 124 has been used by any device for printing for a first time is written. Once written, an initial printing time is no longer rewritten.

A last printing time region 406 is a region in which information indicating a time when each cartridge 124 has been last used by any device for printing is written. A last printing time is updated to a new time as appropriate.

A server authentication result region 407 is a region in which information indicating that the device management server 200 has determined (authenticated) that each cartridge 124 is a predetermined cartridge through a process that will be described later is written.

A server authentication valid period region 408 is a region in which information indicating a valid period of an authentication result written in the server authentication result region 407 is written. In the present embodiment, the valid period is fixed to one week from completion of authentication. A valid period relating to accuracy of a determination of a predetermined article is not limited to this, and may be changed on the basis of specification from the device management server 200, instead.

### Mounted Cartridge List

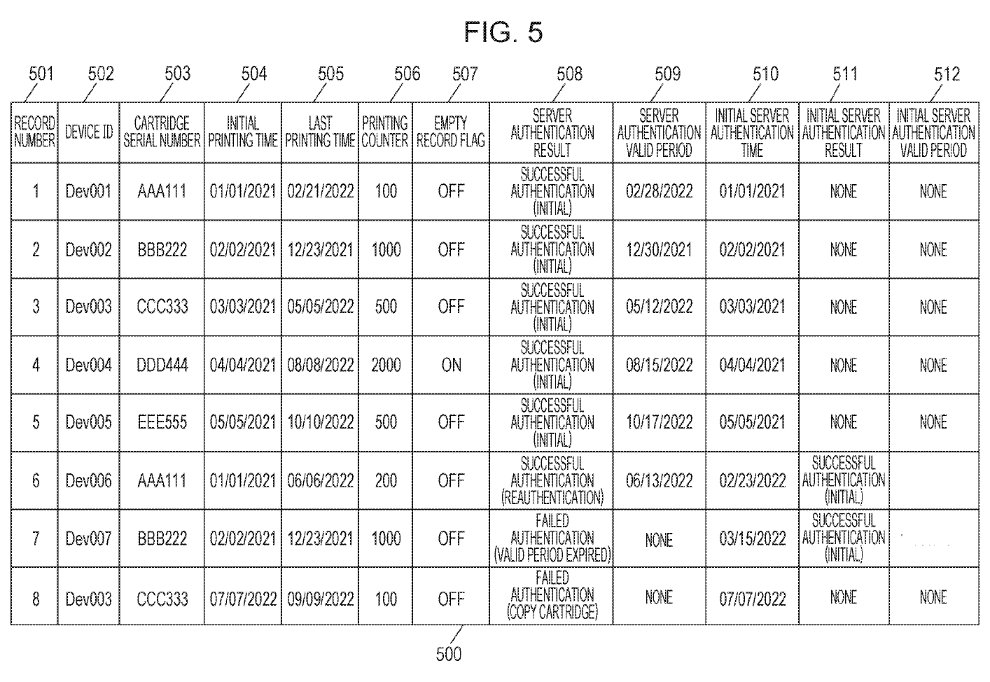

FIG. 5 is a diagram illustrating an example of a mounted cartridge list 500 created on the basis of information collected by the device management server 200 from each image forming apparatus 100.

The device management server 200 is assumed to store the mounted cartridge list 500 in the storage 204.

A record number 501 is a sequential number of each of mounting records in the mounted cartridge list 500. The smaller the record number 501, the older the record, and the larger the record number 501, the newer the record.

A device ID 502 is an ID for identifying a device (image forming apparatus 100) from which the device management server 200 has collected a mounting record of each cartridge 124.

A cartridge serial number 503, an initial printing time 504, and a last printing time 505 are information written in the ID region 401, the initial printing time region 405, and the last printing time region 406 of the cartridge memory 125 of the cartridge 124, respectively.

A printing counter 506 and an empty record flag 507 are information written in the printing counter region 403 and the empty record flag region 404 of the cartridge memory 125 of the cartridge 124, respectively.

A server authentication result 508 and a server authentication valid period 509 are information written in the server authentication result region 407 and the server authentication valid period region 408 of the cartridge memory 125 of the cartridge 124, respectively.

An initial server authentication time 510, an initial server authentication result 511, and an initial server authentication valid period 512 need not necessarily be managed in the mounted cartridge list 500. In the present embodiment, however, the mounted cartridge list 500 is assumed to include these pieces of information for description of an authentication process.

The initial server authentication time 510 is a time when each cartridge 124 is mounted in the image forming apparatus 100 and authenticated for the first time. This tends to be the same date as the initial printing time 504, but can be different when the image forming apparatus 100 is not connected to the communication network 300 at a beginning of use.

The initial server authentication result 511 and the initial server authentication valid period 512 are information written in the server authentication result region 407 and the server authentication valid period region 408 of the cartridge memory 125 of the cartridge 124, respectively.

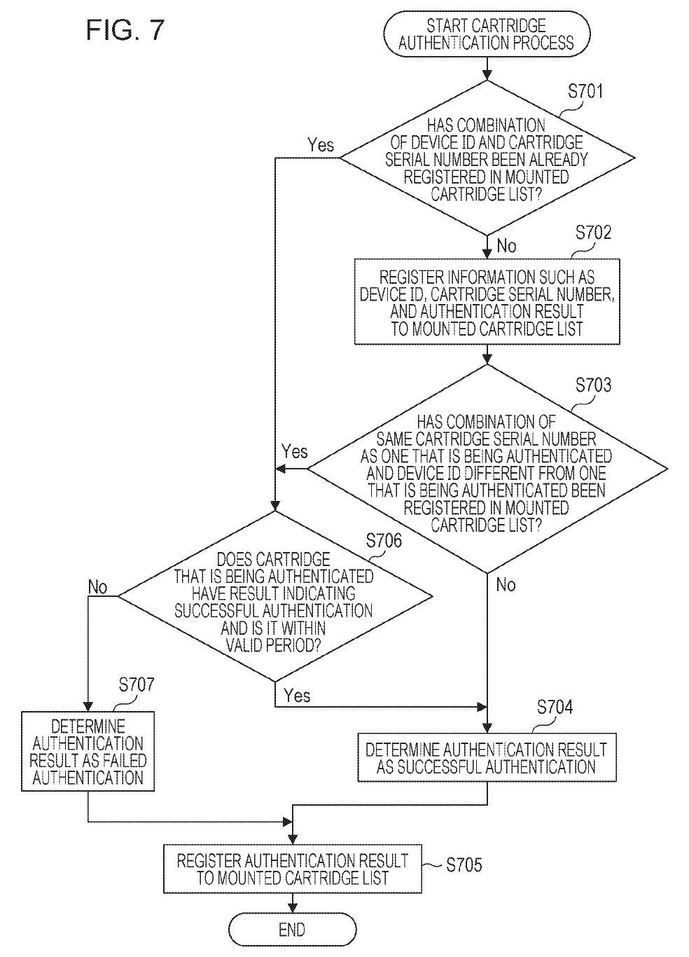

In the present embodiment, the device management server 200 determines whether each cartridge 124 with a record in the mounted cartridge list 500 is a non-predetermined article disguising itself as a predetermined cartridge by copying information stored in the predetermined cartridge. The determination process and a determination result will be described later with reference to FIG. 7.

### Sequence for Authenticating Mounted Cartridge

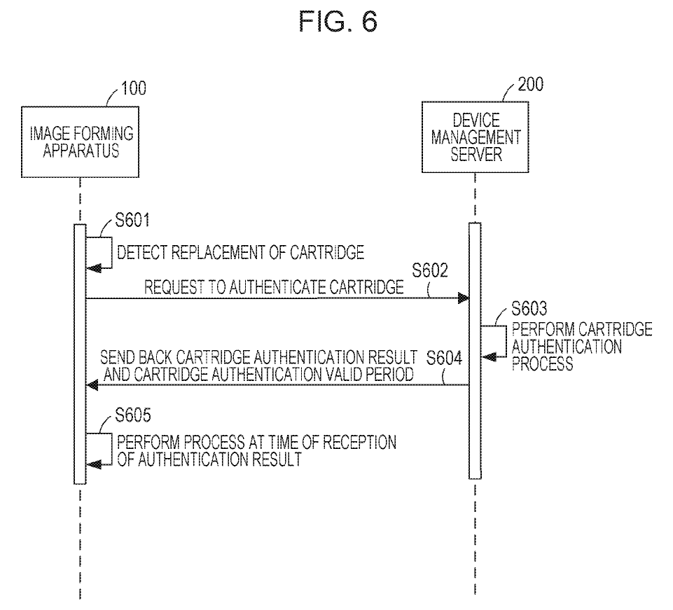

A sequence for authenticating a new cartridge 124 when the cartridge 124 is mounted in the image forming apparatus 100 according to the present embodiment will be described with reference to FIG. 6.

In S601, the CPU 111 of the image forming apparatus 100 detects that the cartridge 124 has been replaced. Although the replacement of the cartridge 124 is determined from the information in the ID region 401 of the cartridge memory 125, other methods may be used for the determination, instead.

In S602, the CPU 111 of the image forming apparatus 100 transmits a request to authenticate the cartridge 124 to the device management server 200. In the present embodiment, the request to authenticate a cartridge 124 is transmitted when the cartridge 124 is mounted, when the image forming apparatus 100 is turned on, or at a predetermined time of the day. The authentication request is transmitted once a day to update the information in the server authentication valid period region 408. Although the authentication request is transmitted at one of these timings in the present embodiment, the authentication request may be transmitted at different timings, instead. The CPU 111 collects the information corresponding to the device ID 502 to the server authentication valid period 509 in the mounted cartridge list 500 from the image forming apparatus 100 and the mounted cartridge 124 and transmits the information to the device management server 200 at the same time as the authentication request.

In S603, upon receiving the request to authenticate the cartridge 124 from the image forming apparatus 100, the CPU 201 of the device management server 200 performs a cartridge authentication process for outputting a determination result indicating whether the cartridge 124 is a predetermined article. Details of the cartridge authentication process will be described later with reference to FIG. 7.

In S604, when the cartridge authentication process is completed, the CPU 201 sends the server authentication result 508 and the server authentication valid period 509 back to the image forming apparatus 100.

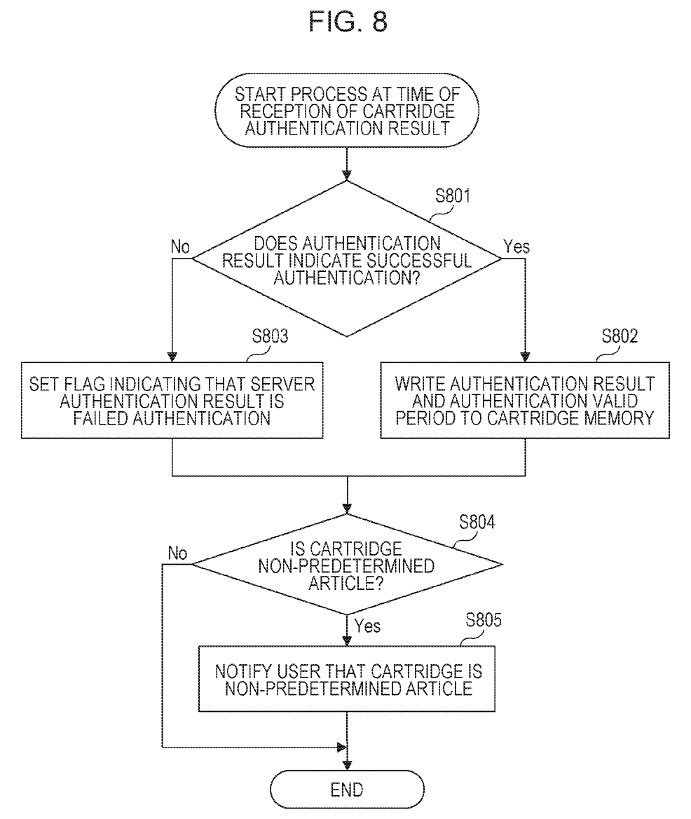

In S605, upon receiving the server authentication result 508, which is a determination result, and the server authentication valid period 509 from the device management server 200, the CPU 111 of the image forming apparatus 100 performs a process at a time of reception of an authentication result. Details of the process at a time of reception of an authentication result will be described with reference to FIG. 8.

### Process at Time of Reception of Authentication Result

FIG. 8 is a flowchart illustrating the process at a time of reception of an authentication result (S605 in FIG. 6) in the image forming apparatus 100. This process is achieved when the CPU 111 of the image forming apparatus 100 loads a program stored in the ROM 112 into the RAM 113 and executes the program.

In S801, the CPU 111 of the image forming apparatus 100 checks whether the server authentication result 508 is successful authentication. If the server authentication result 508 is successful authentication in S801 (YES in S801), the CPU 111 causes the process to proceed to S802, and if the server authentication result 508 is failed authentication (NO in S801), the CPU 111 causes the process to proceed to S803.

### Successful Authentication

In S802, the CPU 111 writes the server authentication result 508 and the server authentication valid period 509 received from the device management server 200 to the server authentication result region 407 and the server authentication valid period region 408 of the cartridge memory 125, respectively, and causes the process to proceed to S804.

### Failed Authentication

In S803, the CPU 111 sets a flag in the RAM 113 indicating that the server authentication result 508 is failed authentication and causes the process to proceed to S804.

Although the server authentication result 508 and the server authentication valid period 509 are written only if the server authentication result 508 is successful authentication in the present embodiment, the server authentication result 508 and the server authentication valid period 509 may be written even if the server authentication result 508 is failed authentication.

In S804, the CPU 111 determines whether the currently mounted cartridge 124 is a non-predetermined article. Whether the cartridge 124 is a non-predetermined article is determined on the basis of not only whether the server authentication result 508 is failed authentication but also whether there is a factor indicating that the image forming apparatus 100 can independently determine that the cartridge 124 is a non-predetermined article. For example, if the cartridge 124 does not include the cartridge memory 125, the cartridge 124 can be determined as a non-predetermined article. The device management server 200 may singlehandedly determine whether a cartridge 124 is a non-predetermined article, instead, and only if the server authentication result 508 is failed authentication, the user may be notified of the result.

If determining that the cartridge 124 is a non-predetermined article (YES in S804), the CPU 111 may cause the process to proceed to S805, and if determining that the cartridge 124 is a predetermined cartridge (NO in S804), the CPU 111 ends the process.

In S805, the CPU 111 notifies the user that the cartridge 124 is a non-predetermined article, and ends the process.

### Non-Predetermined Article Notification Screen

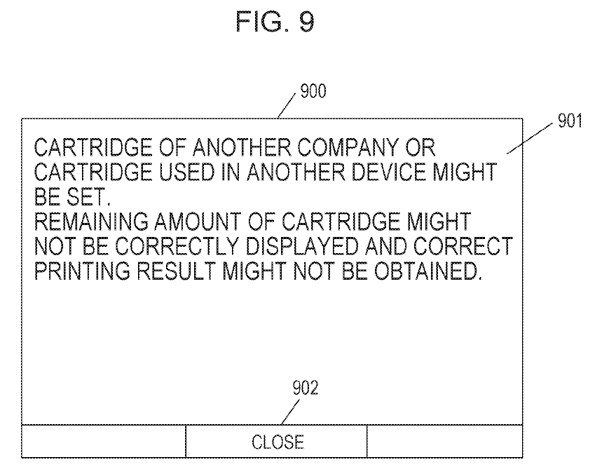

FIG. 9 illustrates an example of a non-predetermined article notification screen 900 for notifying the user that a non-predetermined cartridge 124 is mounted according to the present embodiment. Although the screen illustrated in FIG. 9 is displayed on the operation unit 116 of the image forming apparatus 100 in the present embodiment, the screen need not be displayed on the operation unit 116. For example, the screen may be displayed in an application on an information terminal (for example, a personal computer (PC) (not illustrated)) communicably connected to the image forming apparatus 100 via the communication network 300 or USB to notify the user, instead.

The non-predetermined article notification screen 900 includes a main message portion 901 and a Close button 902. When the user replaces the cartridge 124 and closes a cover of the image forming apparatus 100 or presses the Close button 902, the non-predetermined article notification screen 900 is closed and printing becomes possible.

FIG. 8 is referred to again. In the case of successful authentication as a result of the above-described process, the server authentication result 508 and the server authentication valid period 509 received from the device management server 200 can be written to the cartridge memory 125.

In the case of failed authentication, the user can be notified that the cartridge 124 is a non-predetermined article.

### Cartridge Authentication Process

FIG. 7 is a flowchart illustrating an example of the cartridge authentication process (S603 in FIG. 6) by the device management server 200 according to the present embodiment.

The process is achieved when the CPU 201 of the device management server 200 loads a program stored in the ROM 202 or the storage 204 into the RAM 203 and executes the program.

### Mount New Predetermined Cartridge: Record No. 1

First, the flowchart will be described while taking a process at a time when a cartridge of record No. 1 of the mounted cartridge list 500 illustrated in FIG. 5 is mounted as an example. Record No. 1 corresponds to a use case where a new predetermined cartridge is mounted in the image forming apparatus 100.

First, in S602 in FIG. 6, the device management server 200 receives a request to authenticate the cartridge from the image forming apparatus 100 and starts the following cartridge authentication process (S603).

In S701, the CPU 201 determines whether a combination of the device ID 502 and the cartridge serial number 503 included in the authentication request has already been registered in the mounted cartridge list 500.

Since there are no records of other cartridges and the same combination of the device ID 502 and the cartridge serial number 503 does not exist when information of record No. 1 is received, the CPU 201 determines NO, and causes the process to proceed to S702.

In S702, the CPU 201 registers, to the mounted cartridge list 500, information corresponding to the device ID 502 to the server authentication valid period 509 received when the authentication request has been received.

In S703, the CPU 201 determines whether the mounted cartridge list 500 includes a record in which the same cartridge serial number 503 as that of the cartridge subjected to the authentication process and a device ID 502 different from that of the device subjected to the authentication process are registered.

Since there are no records of other cartridges when the information of record No. 1 is received, the CPU 201 determines NO, and causes the process to proceed to S704.

In S704, after determining NO in S703, the CPU 201 outputs a determination result indicating that a cartridge whose serial number is "AAA111" is a predetermined cartridge and that the authentication has been successfully completed. Since the cartridge of record No. 1 is a new predetermined cartridge, the server authentication result 508 is "none" and the server authentication valid period 509 is "none" at a time of the determination, that is, the authentication, in S704. Since the determination in S704 is initial authentication of this cartridge, these values are saved to the initial server authentication result 511 and the initial server authentication valid period 512. Time information at the time of the determination in S704 is also saved to the initial server authentication time 510.

In the present embodiment, the time information indicates the same time as the initial printing time 504.

In S705, the CPU 201 registers the result indicating successful authentication and the valid period of the authentication to the server authentication result 508 and the server authentication valid period 509 of the mounted cartridge list 500, respectively. Since the server authentication valid period 509 is one week from the time of authentication in the present embodiment, "01/08/2021", which is one week after "01/01/2021" as the initial server authentication time 510, is saved to the server authentication valid period 509. Because the valid period is updated each time authentication is performed once a day thereafter, the server authentication valid period 509 in FIG. 5 is "02/28/2022", which is one week after "02/21/2022" as the last printing time 505.

Information is also registered to the mounted cartridge list 500 and a cartridge is authenticated for each of record Nos. 2 to 5 as for record No. 1.

### Mount Cartridge of Record No. 1 on Another Image Forming Apparatus: Record No. 6

Next, a flowchart will be described while taking a process at a time of mounting of a cartridge of record No. 6 of the mounted cartridge list 500 as an example. Record No. 6 corresponds to a use case where the cartridge of record No. 1, which is a predetermined article, is mounted in another image forming apparatus 100. Differences from the process of record No. 1 will be mainly described.

In S701, the CPU 201 searches for record information of record Nos. 1 to 5, and since the same combination of the device ID 502 and the cartridge serial number 503 as that of record No. 6 does not exist, the CPU 201 determines NO and causes the process to proceed to S702.

Processing in S702 is the same as for record No. 1.

In S703, since there is the cartridge of record No. 1, the cartridge of record No. 6 satisfies a condition that there is a record in which a cartridge serial number of a cartridge is the same and a device ID different from a device ID that is being authenticated is registered. The CPU 201, therefore, determines YES in S703, and causes the process to proceed to S706.

In S706, the CPU 201 determines whether the cartridge that is being authenticated has a result indicating successful authentication and whether it is within the valid period (the valid period has not expired). The cartridge of record No. 6 that is being authenticated has, at the time of the authentication, a last authentication result of the cartridge of record No. 1. That is, the authentication result and the valid period have values of the initial server authentication result 511 and the initial server authentication valid period 512 of record No. 6 of FIG. 5, respectively. That is, the initial server authentication result 511 of record No. 6 is "successful authentication (initial)" of the server authentication result 508 of record No. 1. The initial server authentication valid period 512 of record No. 6 is "02/28/2022" of the server authentication valid period 509 of record No. 1. Therefore, a condition that the cartridge that is being authenticated has a determination result indicating successful authentication and it is within the valid period (since the authentication time of record No. 6 in FIG. 5 is "02/23/2022" of the initial server authentication time 510) is satisfied. As a result, the CPU 201 determines YES in S706, and causes the process to proceed to S704.

Processing in S704 and S705 is the same as for record No. 1.

Even when a predetermined article is mounted in another image forming apparatus 100, too, the predetermined article can thus be correctly authenticated as a predetermined article.

Non-Predetermined Article Created by Copying Memory of Cartridge That Has Been Used: Record No. 7

Next, a flowchart will be described while taking a process at a time of mounting of a cartridge of record No. 7 of the mounted cartridge list 500 as an example. Record No. 7 corresponds to a use case where a non-predetermined cartridge created by copying the cartridge memory 125 of the cartridge of record No. 2 removed before being fully used is mounted in an image forming apparatus 100 different from that of record No. 2. This is a use case where a non-predetermined cartridge including the copied cartridge memory 125 is manufactured and sold and a user different from that of record No. 2 uses the non-predetermined cartridge.

### Differences from the processes of record Nos. 1 and 6 will be mainly described.

In S701, the CPU 201 searches for record information of record Nos. 1 to 6, and since the same combination of the device ID 502 and the cartridge serial number 503 as that of record No. 7 does not exist, the CPU 201 determines NO, and causes the process to proceed to S702.

Processing in S702 is the same as that for record No. 1.

In S703, since there is the cartridge of record No. 2, the cartridge of record No. 7 satisfies the condition that there is a record in which a cartridge serial number 503 is the same and a device ID different from a device ID 502 that is being authenticated is registered. The CPU 201, therefore, determines YES in S703, and causes the process to proceed to S706.

In S706, the cartridge of record No. 7 that is being authenticated has a last authentication result of the cartridge of record No. 2 in the cartridge memory 125 at a time of the authentication. That is, the authentication result, which is the determination result, and the valid period have values of the initial server authentication result 511 and the initial server authentication valid period 512 of record No. 7 in FIG. 5, respectively. That is, the initial server authentication result 511 of record No. 7 is "successful authentication (initial)" of the server authentication result 508 of record No. 2. The initial server authentication valid period 512 of record No. 7 is "12/30/2021" of the server authentication valid period 509 of record No. 2. Therefore, the condition that the cartridge that is being authenticated has a result indicating success authentication and it is within the valid period is not satisfied. This is because the authentication time of record No. 7 in FIG. 5 is "03/15/2022" as in the initial server authentication time 510 and the initial server authentication valid period 512 is "12/30/2021". As a result, the CPU 201 determines NO in S706, and causes the process to proceed to S707.

In S707, since the CPU 201 has determined NO in S706, the CPU 201 determines that the cartridge of record No. 7 is a non-predetermined cartridge, determines "failed authentication (valid period expired)", and causes the process to proceed to S705.

In S705, the CPU 201 registers the result indicating failed authentication to the server authentication result 508 of the mounted cartridge list 500. Since the authentication result is "failed authentication (valid period expired)", "none" is registered to the server authentication valid period 509 in the present embodiment.

### Non-Predetermined Article Created by Copying New Cartridge Memory: Record No. 8

Lastly, a flowchart will be described while taking a process at a time of mounting of a cartridge of record No. 8 of the mounted cartridge list 500 as an example. Record No. 8 corresponds to a use case where a non-predetermined cartridge created by copying a cartridge memory of the cartridge of record No. 3 when the cartridge of record No. 3 is new is mounted in the same image forming apparatus 100 as that of record No. 3.

### Differences from the processes of record Nos. 1, 6, and 7 will be mainly described.

In S701, the CPU 201 searches for record information of record Nos. 1 to 7, and since record No. 3 includes the same combination of the device ID 502 and the cartridge serial number 503 as that of record No. 8, the CPU 201 determines YES, and causes the process to proceed to S706.

In S706, the authentication result and the valid period of the cartridge of record No. 8 that is being authenticated have values of the initial server authentication result 511 and the initial server authentication valid period 512 in record No. 8 in FIG. 5. That is, both are "none". Therefore, the condition that the cartridge that is being authenticated has a result indicating successful authentication and it is within the valid period is not satisfied. As a result, in S706, the CPU 201 determines NO, and causes the process to proceed to S707.

In S707, since the CPU 201 has determined NO in S706, the CPU 201 determines that the cartridge of record No. 8 is a non-predetermined cartridge, and since there is no valid period, determines "failed authentication (copy cartridge)".

By performing the control described above, the predetermined cartridges of record Nos. 1 to 6 can be recognized as predetermined cartridges, and successful authentication can be determined. Non-predetermined cartridges of record Nos. 7 and 8 created by copying cartridge memories of predetermined cartridges, on the other hand, can be recognized as non-predetermined cartridges, and failed authentication can be determined. As a result, when a non-predetermined consumable storing copied information is mounted in an image forming apparatus, the user can be notified of the mounting of the non-predetermined consumable.

Although toner cartridges mounted in image forming apparatuses of the electrophotographic type have been described as an example, the present disclosure is not limited to this. That is, image forming apparatuses may be ones of another method such as inkjet, and in this case, a server communicable over a network may determine whether consumables such as ink cartridges are predetermined articles. In addition, any consumables of image forming apparatuses may be used instead of toner cartridges. For example, thermal image forming apparatuses may determine whether thermal paper rolls are predetermined articles. Alternatively, inkjet image forming apparatuses with replaceable heads may determine whether the heads are predetermined articles. Alternatively, plotters or the like may determine whether consumables such as pens are predetermined articles.

Any apparatuses in which consumables are mounted and used may be used instead of image forming apparatuses. For example, the present disclosure can be applied to determinations whether lamps of image projection apparatuses, batteries used in electronic devices in general, or the like are predetermined articles.

According to the present disclosure, accuracy of detecting a non-predetermined cartridge storing copied information can be improved, and when a non-predetermined cartridge is mounted in an image forming apparatus, the user can be notified of the mounting of the non-predetermined cartridge.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-211077, filed December 4, 2024, which is hereby incorporated by reference herein in its entirety.

What is claimed is:

1. An information processing system comprising:
an image forming apparatus; and
an information processing apparatus communicable with the image forming apparatus over a network,
wherein the information processing apparatus includes:
at least one memory that stores a set of instructions; and
at least one processor that executes the instructions causing the information processing apparatus to perform operations comprising:
a reception unit configured to receive information regarding a consumable mounted in the image forming apparatus,
a determination unit configured to determine whether the consumable is a predetermined consumable on a basis of the information regarding the consumable and information regarding another consumable stored before the information regarding the consumable is received from the image forming apparatus, and
a first transmission unit configured to transmit a determination result obtained by the determination unit to the image forming apparatus,
wherein the information regarding the other consumable includes a last determination result obtained by the determination unit and a valid period, and
wherein the image forming apparatus includes:
at least one memory that stores a set of instructions; and
at least one processor that executes the instructions causing the image forming apparatus to perform operations comprising:
a writing unit configured to write, if the determination result received from the information processing apparatus indicates the predetermined consumable, information regarding the determination result and a valid period to a memory of the mounted consumable, and
a second transmission unit configured to transmit an inquiry including the information written to the memory of the consumable to the information processing apparatus.

2. The information processing system according to claim 1,
wherein if the information regarding the other consumable includes the last determination result and it is within the valid period of the last determination result, the determination unit determines that the consumable is the predetermined consumable, and the first transmission unit transmits the determination result.

3. The information processing system according to claim 1,
wherein if the information regarding the other consumable includes the last determination result and it is not within the valid period of the last determination result, the determination unit determines that the consumable is not the predetermined consumable, and the first transmission unit transmits the determination result.

4. The information processing system according to claim 1,
wherein if the information regarding the other consumable does not include the last determination result, the determination unit determines that the consumable is not the predetermined consumable, and the first transmission unit transmits the determination result.

5. The information processing system according to claim 1,
wherein the image forming apparatus further includes a notification unit configured to notify, if the image forming apparatus receives a determination result indicating that the consumable is a non-predetermined consumable from the information processing apparatus, a user that the consumable is the non-predetermined consumable.

6. The information processing system according to claim 5,
wherein the notification unit notifies an information terminal connected to the network.

7. The information processing system according to claim 1,
wherein the consumable is a toner cartridge.

8. The information processing system according to claim 1,
wherein the inquiry is issued when a consumable is replaced, when the image forming apparatus is turned on, or at a predetermined time of day.

9. A method for controlling an information processing system including an image forming apparatus and an information processing apparatus communicable with the image forming apparatus over a network, the method comprising:
receiving, with the information processing apparatus, information regarding a consumable mounted in the image forming apparatus;
determining, with the information processing apparatus, whether the consumable is a predetermined consumable on a basis of the information regarding the consumable and information regarding another consumable stored before the information regarding the consumable is received from the image forming apparatus;
transmitting, with the information processing apparatus, a determination result obtained in the determining to the image forming apparatus,
the information regarding the other consumable including a last determination result obtained in the determining and a valid period;
writing, with the image forming apparatus, information regarding the determination result received from the information processing apparatus and a valid period to a memory of the mounted consumable if the determination result indicates the predetermined consumable; and
transmitting, with the image forming apparatus, an inquiry including the information written to the memory of the consumable to the information processing apparatus.
